(19) United States
(12) Patent Application Publication
(10) Pub. No.: US 2015/0130938 A1
(43) Pub. Date: May 14, 2015

(54) Vehicle Operational Display

(71) Applicant: Dan A. Vance, San Diego, CA (US)

(72) Inventor: Dan A. Vance, San Diego, CA (US)

(21) Appl. No.: 14/077,141

(22) Filed: Nov. 11, 2013

(51) Int. Cl. B60R 11/04

(52) U.S. Cl. CPC B60R 11/04; B60R 2300/20; B60R 2300/105; B60R 2300/304
USPC 348/148

(57) ABSTRACT

A system for presenting visual information to the operator of a vehicle at an apparent single plane of focus regardless of the viewer-to-object distance. The system includes an imaging device configured to capture images external to a vehicle. The system also includes a display configured to show the images captured by the imaging device to the operator and superimpose informational parameters onto the images.

### CROSS REFERENCE TO RELATED APPLICATIONS

This application claims the benefit of Provisional application Ser. No. 61/725,386, filed on Nov. 12, 2012.

### BACKGROUND OF THE INVENTION

Head-up displays (HUDs) have been in use in military aircraft for some time. Expansion of use to other vehicles, such as private aircraft and automobiles, has been hampered by economic and technological factors.

In the case of HUDs in aircraft, an apparent image, usually a graphic or textual representation of data such as speed or distance to nearest object, is projected on a semi-transparent screen in front of the pilot. The apparent image is collimated so that it appears to be in focus at infinity. This allows the pilot to see real objects (mainly, other aircraft) through the screen, as well as the apparent image, which appears to be superimposed on the real view. This technique works acceptably in this application, because most real objects seen from the cockpit are far enough away as to be essentially in focus at infinity, as is the apparent image.

A problem arises with objects that are closer to the user. This is especially true when HUDs are intended for automotive use, since in normal driving, other vehicles may be very close. The proximity of real objects with respect to the apparent image which is focused at a long distance (effectively, at infinity) requires that the driver shift focus from the apparent image to the real objects, which are at varying distances. This difference in focus prevents the operator of a device, machine or vehicle from having attention on more than one item of visual information at any precise moment. In a time-critical event, such as a vehicle ahead suddenly stopping, if the user's eyes are focused on the apparent image instead of the vehicle, detection of the sudden stopping of the vehicle is delayed. This delay can mean the difference between stopping short and colliding with the vehicle.

What is needed then is a display system that does not require a shift in focus between the apparent image and the real view. The system and method of the proposed invention provides this capability.

### BRIEF SUMMARY OF THE INVENTION

In one aspect of the invention, an imaging device is positioned in a vehicle to capture an approximate image of the external view seen by the operator in normal operation of the vehicle. A display device is positioned so as to be within view of the operator without obstructing the operator's normal view from the vehicle. The image from the imaging device is displayed on the display device. Vehicle operational parameters are converted to graphical, videographical, or textual representations and are superimposed on the image. The vehicle operator is then able to simultaneously view the vehicle operational information and the external view from the vehicle all in the same focal plane, namely the face of the display device.

By using a camera imager, lens and aperture of selected parameters, the depth of field of the captured image can be such that objects near the vehicle as well as objects at optical infinity are all in sharp focus on the display. That is, the hyperfocal distance of the system can be on the order of less than a few feet.

The operator can safely operate the vehicle by viewing either the normal real view, through the windshield, or the displayed image. Because an imaging device is used to display the view, the field of view is not restricted to the normal field of view of the eye. Using a lens of short focal length on the imaging device, for example, would enable the driver to see objects to the sides (or above or below) that would normally be out of view through the windshield, due to the limit of the eye's field of view or obstructions in the vehicle, such as the structural pillar posts that support the front of the roof of the vehicle.

Using an imaging system gives further versatility. If it is desired to keep the view as similar to the ‘eye’ view as possible, optical and signal processing means are still available to enhance the driver's view. For example, a wide screen display could show the normal view in the main center portion of the screen, while showing horizontally compressed images of the left and right view. Or the display could show the center and side mounted rear-view mirror images on portions of the display, so that the driver does not need to take his or her eyes off the road even to glance in the “rear-view mirrors.”

### BRIEF DESCRIPTION OF THE DRAWINGS

FIG. 1 is a block diagram of an embodiment of the invention.

### DETAILED DESCRIPTION OF THE DRAWINGS

Reference will now be made to the figure, which is a diagrammatic representation of an embodiment of the invention, and is not limiting of the present invention:

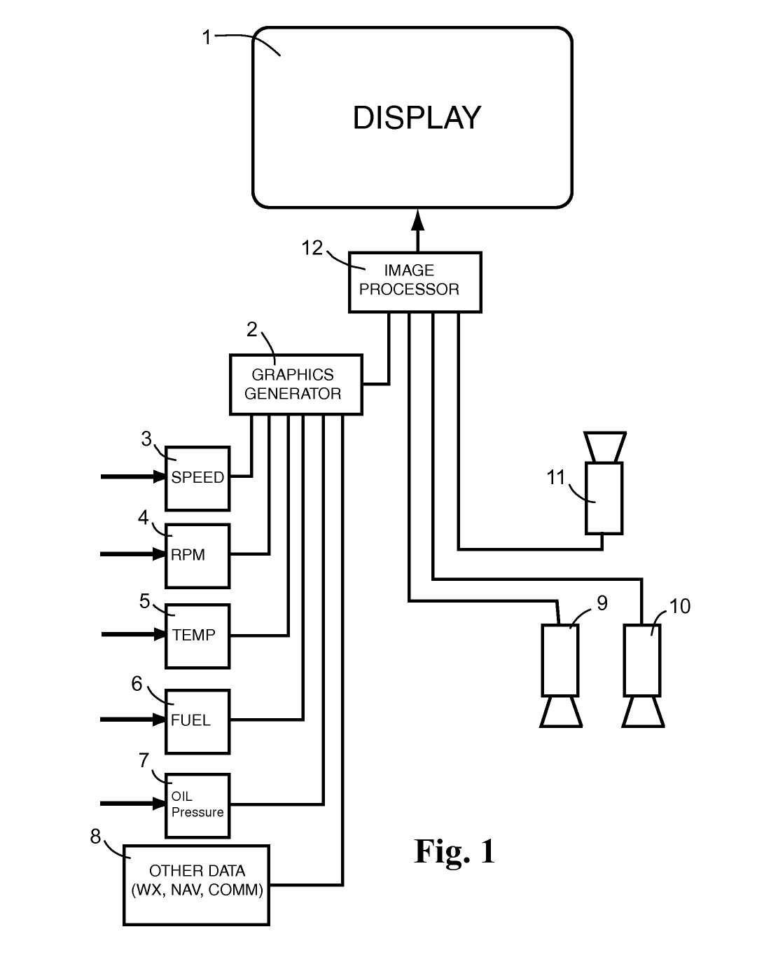

Referring to FIG. 1, an imaging device such as a video camera 11 is configured to capture a field of view from a vehicle which approximates the forward view seen by the operator of the vehicle, and is further configured to have a depth of field such that objects external to the vehicle are in focus regardless of distance from the vehicle. The imaging signal from the imaging device 11 is fed to an image processor 12. Likewise, second and third imaging devices 9 and 10 are configured to capture fields of view approximating the views seen by the operator in conventional left and right side-view mirrors respectively, of the vehicle, and are further configured to each have a depth of field such that objects external to the vehicle are in focus regardless of distance from the vehicle. The imaging signals from imaging devices 9 and 10 are fed to the image processor 12. Vehicle operational parameters are sensed by vehicle sensors 3 through 7. The outputs of the sensors 3 through 7 are fed to a graphics generator 2, which converts the signals to graphically-interpretable elements which are then fed to the image processor 12. Other data is collected by data module 8. The output of the data module 8 is fed to the graphics generator 2 which converts the signals to graphically-interpretable elements which are then fed to the image processor 12. The image processor 12 combines the signals from the imaging devices 9, 10 and 11 and the graphics generator 2 and drives the display 1 to display the images of the imaging devices 9, 10 and 11 along with superimposed graphical elements representing the signals of the vehicle sensors 3 through 7 and the other data of the data module 8.

The terms and expressions which have been employed in the foregoing specification are used therein as terms of description and not of limitation, and there is no intention, in the use of such terms and expressions, of excluding equivalents or alternatives of the elements shown and described or portions thereof, it being recognized that the scope of the invention is defined and limited only by the claims which follow.

I claim:

1. A system for presenting visual information to the operator of a vehicle under direct local control at an apparent single plane of focus regardless of the operator-to-object distances, the system comprising:
two or more imaging devices configured to capture fields of view approximating any forward, sidewards or rearward fields of view as seen by the operator of the vehicle from the normal operating position, and further configured to have a depth of field such that all external objects imaged by the imaging devices are in focus regardless of distance;
one or more devices configured to capture data relevant to vehicle operation or otherwise of interest to the operator and convert said data to graphic elements superimposable on a display device;
an image display device positioned so as to be viewable by the vehicle operator without obstructing the operator's normal view from the vehicle, and configured to display said images captured by the imaging devices to the operator of the vehicle along with said superimposable elements.

2. The system of claim of 1, wherein one or more of the imaging devices capture image information outside the human visual perception range, and the display device displays said information so as to be viewable by the operator of the vehicle.

3. The system of claim 1, wherein the superimposed element is at least one of:
vehicle speed;
vehicle powerplant rpm;
vehicle fuel level;
vehicle powerplant temperature;
ambient temperature;
vehicle mileage;
vehicle powerplant coolant temperature;
vehicle powerplant oil temperature;
vehicle navigational information;
vehicle turn signal status;
vehicle headlight brightness setting;
vehicle cruise control status.

4. A system for presenting visual information to the operator of a vehicle under direct local control at an apparent single plane of focus regardless of the operator-to-object distances, the system comprising:
an imaging device configured to capture the forward field of view approximating the field of view as seen by the operator of the vehicle from the normal operating position, and further configured to have a depth of field such that all external objects imaged by the imaging device are in focus regardless of distance from the vehicle;
one or more devices configured to capture data relevant to vehicle operation or otherwise of interest to the operator and convert said data to graphic elements superimposable on a display device;
an image display device positioned so as to be viewable by the vehicle operator without obstructing the operator's normal view from the vehicle, and configured to display said images captured by the imaging devices to the operator of the vehicle along with said superimposable elements.

5. The system of claim of 4, wherein the imaging device captures image information outside the human visual perception range, and the display device displays said information so as to be viewable by the operator of the vehicle.

6. The system of claim 4, wherein the superimposed element is at least one of:
vehicle speed;
vehicle powerplant rpm;
vehicle fuel level;
vehicle powerplant temperature;
ambient temperature;
vehicle mileage;
vehicle powerplant coolant temperature;
vehicle powerplant oil temperature;
vehicle navigational information;
vehicle turn signal status;
vehicle headlight brightness setting;
vehicle cruise control status.

7. A method for presenting visual information to the operator of a vehicle under direct local control, said visual information being presented at an apparent single plane of focus regardless of the operator-to-object distances, the system comprising:
capturing images external to a vehicle, wherein the captured images approximate the views normally visible to the operator of the vehicle, said images having a depth of field such that all objects external to the vehicle are in focus regardless of distance from the vehicle;
superimposing at least one graphical, videographical or textual information parameter onto the image;
displaying the images to the vehicle operator.
